(19) United States
(12) Patent Application Publication
(10) Pub. No.: US 2013/0092657 A1
(43) Pub. Date: Apr. 18, 2013

(54) CROSS-LINKING AND MULTI-PHASE ETCH PASTES FOR HIGH RESOLUTION FEATURE PATTERNING

(71) Applicants: Jennifer Gillies, Cambridge, MA (US); Ralf Kuegler, Ludwigshafen (DE); Eric Stern, Cambridge, MA (US); Brian Mayers, Somerville, MA (US); Patrick Reust, Somerville, MA (US); Lindsay Hunting, Cambridge, MA (US)

(72) Inventors: Jennifer Gillies, Cambridge, MA (US); Ralf Kuegler, Ludwigshafen (DE); Eric Stern, Cambridge, MA (US); Brian Mayers, Somerville, MA (US); Patrick Reust, Somerville, MA (US); Lindsay Hunting, Cambridge, MA (US)

(73) Assignees: NANO TERRA, INC., Cambridge, MA (US); MERCK PATENT GESELLSCHAFT MIT BESCHRANKTER HAFTUNG, Darmstadt (DE)

(21) Appl. No.: 13/703,966

(22) PCT Filed: May 17, 2011
(86) PCT No.: PCT/EP11/02427

§ 371 Date: Dec. 13, 2012

Related U.S. Application Data
(60) Provisional application No. 61/354,454, filed on Jun. 14, 2010.

(51) Int. Cl. C09K 13/06

(52) U.S. Cl. CPC C09K 13/06; Y10S 977/773; B82Y 30/00
USPC 216/94; 252/79.1; 252/79.2; 216/96; 216/99; 977/773

(57) ABSTRACT

The present invention relates to a novel etching media in the form of printable, homogeneous etching pastes with non-Newtonian flow properties for the improved etching of inorganic oxides and silicon surfaces and which allow to prepare smaller features.

### TECHNICAL FIELD

The present invention relates to a novel etching media in the form of printable, homogeneous etching pastes with non-Newtonian flow properties for the improved etching of inorganic oxides and silicon surfaces and which allow to prepare smaller features.

### BACKGROUND OF THE DISCLOSURE

Today's photovoltaic systems are predominantly based on the use of crystalline silicon, thin-film and concentrator photovoltaic technologies.

In the near past technologies and compositions have been developed for simplifying processes for producing electronic structures with high resolution in semiconductor devices. Especially the development of etching pastes, which are suitable to be applied by direct printing onto the surface areas to be etched simplifies the structuring process, because the application of protective resin layers on areas, which shall remain untouched during the etching process, may be left out. Said new etching compositions may be printed with high resolution. Applicable etching pastes are traded under the brand logo Isishape®. This family of etching pastes has been developed by the German company Merck for patterning etched features down to 40 microns by a variety of deposition methods. These etching pastes offer a low cost and environmentally favourable alternative to the traditional methods which require photolithographic resist masking followed by bath etching.

In the past several patents and patent applications were published (US 2004/0242019 A1, US 2006/0118759 A1, US2005/0247674 A1, US 2003/0160026 A1 and Us 2003/0119332 A1), which disclose etching compositions, but none of the compositions is suitable for the etching of small features of less than 40 μm.

### OBJECTIVE

In the Isishape® etching process a specially formulated etching paste is deposited onto a substrate only where the etching is desired. After the etching is complete, the etching paste and the etched material are washed away. Additionally in some etch processes there is a heating step required to activate the etching paste. Formulating etching pastes for high resolution deposition processes poses a particularly difficult problem, because of two competing issues. The paste must be sufficiently non-viscous so as to enable the fine feature formation. However, the paste must be sufficiently viscous such that the pattern of the deposited paste is not compromised by seepage of the etching paste into areas where etching is not desired. Presently the Isishape® etching process can be used to attain pattern sizes down to 40 microns, but there are applications for which it is desirable to etch smaller feature sizes. Thus there is a need for new etching compositions which provide a solution for extending the feature size down to 10 microns using the same deposition methods used in the current Isishape® etching process.

### BRIEF DESCRIPTION OF THE INVENTION

The object of the present invention is a new class of etching paste compositions which is suitable for the etching of silicon, silicon dioxide, indium tin oxide, or further inorganic surfaces comprising components suitable for the encasing of a contained etchant, whereby the encasing of the applied etching composition is induced by irradiation with light, heat or another energy source. A special configuration of the invention is that the encasing of the etching composition is induced after application onto a surface to be etched whereas simultaneously the etching step is activated. The components suitable for the encasing are present in a concentration of between about 1-70%, preferably in a concentration of between about 1-50%, especially preferred in a concentration of between about 5-20%. Etching paste according to the present invention comprise monomer(s) and/or crosslinker(s), selected from the group: olefin, diene, acetylene, acrylate, methacylate, acrylamide, acrylonitrile, vinyl acetate or other vinyl, styrene, and thiol (di, tri, etc) which may be contained as such or as mixtures. To obtain the encasing according to the invention the composition comprises a UV/thermal initiator, which is compatible with the comprising monomer(s) and/or crosslinker(s). Particularly good etching results are achieved because the etching paste comprises two or more phases, which are stabilized by a surfactant in a concentration sufficient for stabilization these two or more phases. Said surfactant is present in the etching paste according to the invention in a concentration of between about 1-90% preferably in a concentration of between about 10-80% and most preferred in a concentration of between about 15-75%. In addition the contained surfactant comprises at least one of: a hydrophilic moiety, an oleophilic moiety, or a fluorophilic moiety, or a combination thereof. This means, that the Etching paste according to the invention comprises two or more phases; a surfactant in a concentration sufficient for stabilization of the two or more phases; and components suitable for the encasing of a contained etchant. Good etching results are achieved with etching pastes comprising inorganic particles in a concentration sufficient to increase the thixotropy of the etching paste. Especially the inorganic nanoparticles are present in a concentration of between about 1-70%, preferably in a concentration of between about 1-50%, especially preferred in a concentration of between about 5-20%. Comprising inorganic nanoparticles may be selected from the group fumed silica, carbon black, or a combination of them may be contained. Suitable etchants for the inventive composition are phosphoric acid, ferric chloride, oxalic acid, tartaric acid, hydrofluoric acid, sulphuric acid, nitric acid, acetic acid, or a combination thereof.

Object of the invention is also a method for the etching of silicon, silicon dioxide, or indium tin oxide surfaces, which is characterized in that the etchant is encased to form a gel after the application of the etching composition onto the surface to be etched. The encasing of the etchant is induced by irradiation with light or heat and/or by temperature-induced removal of a comprising solvent from a two- (or more) solvent system.

### DETAILED DESCRIPTION OF THE INVENTION

As described above the object of the present invention are new etching paste compositions, which are suitable for the etching of silicon, silicon dioxide, indium tin oxide, or further inorganic surfaces comprising components suitable for the encasing of contained etchant. The pastes of the present invention can be used separately or in conjunction, and are capable of achieving sub-40 micron etching. In a first embodiment, the invention is directed to a cross-linkable class of pastes comprising components that enable irradiation-induced encasing of the etchant with light or heat. Advantageously the encasing may be induced after application onto the surface to be etched. In a second embodiment, the invention is directed to a multi-phase class of pastes comprising a stabilized emulsion that maintains feature fidelity at high temperature (90° C.). In special cases the pastes may be thixotrpic and in order to increase the thixotropy of the compositions, inorganic particles, which may be fumed silica or carbon black or others, can be incorporated. Preferably compositions according to the present invention comprise phosphoric acid as an etchant but can also contain ferric chloride or oxalic acid and/or tartaric acid, and the like.

The cross-linkable pastes become a gel after irradiation-induced cross-linking. This gel encases the etchant, preventing feature disintegration during etching. For aqueous-phase etchants, such as phosphoric acid for indium tin oxide or hydrofluoric acid for silicon dioxide, a hydrogel is formed. For organic-phase etchants, an oleogel is formed. In both cases, the paste composition comprises monomer(s) and/or crosslinker(s), selected from the group olefin, diene, acetylene, acrylate, methacylate, acrylamide, acrylonitrile, vinyl acetate or other vinyl, styrene, and thiol (di, tri, etc), which can be contained as such or as mixtures. The polymerization of these monomers may be initiated by a comprising UV or thermal initiator, which is compatible with the comprising monomer(s) and/or crosslinker(s). The polymerization can be free radical, anionic, cationic, a mixture of these, or a condensation or metal-catalyzed polymerization. In a preferred embodiment the encasing of the etchant to form a hydrogel is performed after the application of the etching composition onto the surface to be etched. The encasing step may be induced by irradiation with light or heat. In a special embodiment of the invention the encasing step of the etchant to form the hydrogel can be induced by temperature-induced removal of a solvent from a two- (or more) solvent system.

The multi-phase pastes contain at least one surfactant in addition to the etchant. The surfactant can be hydrophilic-oleophilic, such as Span®, Tween®, Brij®, etc., hydrophilic-fluorophilic, such as Zonyl®, or oleophilic-fluorophilic, such as hydrocarbon-fluorocarbon chains. The etchant can be in either the inner or outer phase but is preferentially in the outer phase. With the etchant in the outer phase, the surfactant is added above the critical micelle concentration (CMC) of the system. The resulting micelles serve as viscosity enhancers.

This means, that the core of the present invention is the development of a new etching paste, which possesses physical properties to be printed in fine lines thinner than 40 μm, preferably which may be printed with features sized down to 10 μm. It goes without saying, that the pastes according to the present invention may also be applied for the etching of features >40 μm. But even here the compositions according to the invention led to improved etching results, for example an improved edge definition was found.

Series of experiments led to the development of a new etching paste formulation, which may be printed with feature sizes down to 10 microns and which remain nearly unchanged after printing with the result, that etched lines and features show nearly the same resolutions as the printed feature.

Another aspect of the present invention is the development of new etching paste formulations, in which

1. chemical or physical changes of properties are directly initiated following
the deposition of the etching paste onto the surfaces and/or

2. a multi-phase system is built for viscosity enhancement.

In a first embodiment, the resulting gel effectively encases the etchant and, in turn, prevents seepage of the etchant into surrounding regions.

For a first embodiment, examples of enabling materials include polymeric materials, initiators, and inhibitors, which gel the etching paste at a controlled rate through chemical crosslinking initiated by irradiation, especially by light or heat. This approach is not limited to a chemical crosslinking. For example, temperature-induced removal of a solvent from a two- (or more) solvent system may precipitate out a polymer that serves to cage the etchant similarly to the gel described above.

The formulation must be balanced to create an encapsulation of the etching paste and at the same time permit sufficient mobility of the etching paste to effectively contact the surface for complete etching. Also, the etchant must be formulated in such a way that the gel encapsulation takes place after deposition to avoid clogging or other deleterious effects on the deposition equipment.

Additionally the chosen compositions have to be stable in the presence of added echant, which are suitable for the etching of silicon, silicon dioxide, indium tin oxide, or further inorganic surfaces. Experiments have shown, that suitable etchants for the inventive composition are phosphoric acid, ferric chloride, oxalic acid, tartaric acid, hydrofluoric acid, sulphuric acid, nitric acid, acetic acid, or combinations thereof.

The proportion of etching components employed is in a concentration range of 2-55% by weight, preferably 5-50% by weight, based on the total weight of the etching paste. Particular preference is given to etching media in which the etching components are present in an amount of 10-50% by weight. Particularly suitable are etching media in which the etching component(s) is (are) present in an amount of 25-50% by weight, based on the total weight of the etching paste, since etching rates found for etching media of this type and semiconductor elements facilitate treatment with high throughput. At the same time, these etching pastes show high selectivity for the surface layers to be etched.

The etching formulation requires at least one etchant suitable for inorganic surfaces, which may or may not be temperature sensitive, at least one UV/thermal-curable monomer and/or crosslinker, selected from the group olefin, diene, acetylene, acrylate, methacylate, acrylamide, acrylonitrile, vinyl acetate or other vinyl, styrene, and thiol (di, tri, etc), which can be contained as such or as mixtures.

In this first embodiment the monomer concentration is between about 1-70%, preferably about 1-50%, and most preferably between about 5-20%. The crosslinker concentration is between about 0.1-25%, preferably about 0.1-15%, and most preferably about 0.5-10%. The initiator concentration is between about 0.1-20%, preferably about 0.1-15%, and most preferably about 0.5-10%.

In addition the formulation may comprise a compatible UV/thermal initiator and thixotropic or viscosity enhancers suitable for use with additional embodiments described herein. Cross-linking inhibitors may also be added.

In a second embodiment, a multi-phase paste comprises at least one surfactant in addition to the etchant. The surfactant can preferentially separate either into or out of the etchant solution. Not being bound by theory, in the latter case, the surfactant can facilitate the formation and stabilization of etchant particles in a paste of a different phase. In the former case, the surfactant is used above its CMC (critical micelle concentration) in the solvent to induce the formation of micelles in the paste, which enhance viscosity. The micelles can function as organic nanoparticles that enhance viscosity in a manner similar to inorganic nanoparticles, but without detrimental effects on durability that are associated with inorganic nanoparticles. The surfactants can be from one or more of the following classes: hydrophilic-oleophilic, hydrophilic-fluorophilic, and oleophilic-fluorophilic. Surfactants containing hydrophilic moieties can be cationic, anionic, zwitterionic, or non-ionic. Potential surfactants include alkyl sulfates: ammonium lauryl sulfate, sodium lauryl sulfate (SDS); alkyl ether sulfates: sodium laureth sulfate, also known as sodium lauryl ether sulfate (SLES), sodium myreth sulfate; sulfonates: dioctyl sodium sulfosuccinate, perfluorooctanesulfonate (PFOS), perfluorobutanesulfonate; alkyl benzene sulfonates; phosphates: alkyl aryl ether phosphate, alkyl ether phosphate; carboxylates; alkyl carboxylates: Fatty acid salts: sodium stearate, sodium lauroyl sarcosinate; perfluorononanoate, perfluorooctanoate (PFOA or PFO); octenidine dihydrochloride; alkyltrimethylammonium salts: cetyl trimethylammonium bromide (CTAB), cetyl trimethylammonium chloride (CTAC); cetylpyridinium chloride (CPC); polyethoxylated tallow amine (POEA); benzalkonium chloride (BAC); benzethonium chloride (BZT); 5-bromo-5-nitro-1,3-dioxane; dimethyldioctadecylammonium chloride; dioctadecyldimethylammonium bromide (DODAB); sulfonates: CHAPS (3-[(3-cholamidopropyl)dimethylammonio]-1-propanesulfonate); sultaines: cocamidopropyl hydroxysultaine; carboxylates: amino acids, imino acids; betaines: cocamidopropyl betaine; phosphates: lecithin; fatty alcohols: cetyl alcohol, stearyl alcohol, cetostearyl alcohol (consisting predominantly of cetyl and stearyl alcohols), oleyl alcohol; polyoxyethylene glycol alkyl ethers (Brij): CH₃—(CH₂)₁₀₋₁₆—(O—C₂H₄)₁₋₂₅—OH, octaethylene glycol monododecyl ether, pentaethylene glycol monododecyl ether; polyoxypropylene glycol alkyl ethers: CH₃—(CH₂)₁₀₋₁₆—(O—C₃H₆)₁₋₂₅—OH; glucoside alkyl ethers: CH₃—(CH₂)₁₀₋₁₆—(O-Glucoside)₁₋₃-OH: decyl glucoside, lauryl glucoside, octyl glucoside; polyoxyethylene glycol octylphenol ethers: C₈H₁₇—(C₆H₄)—(O—C₂H₄)₁₋₂₅—OH: Triton X-100; polyoxyethylene glycol alkylphenol ethers: C₉H₁₉—(C₆H₄)—(O—C₂H₄)₁₋₂₅—OH: Nonoxynol-9; glycerol alkyl esters: glyceryl lauratel; polyoxyethylene glycol sorbitan alkyl esters: polysorbates; sorbitan alkyl esters: Spans and Tweens; cocamide MEA, cocamide DEA; dodecyl dimethylamine oxide; block copolymers of polyethylene glycol and polypropylene glycol like Poloxamers.

In some embodiments, a surfactant is present in a concentration of about 1-90%, preferably of about 10-80%, and most preferably about 15-75% by weight.

The invention covers the use of either embodiment independently or both independents used together.

To increase paste thixotropy in either embodiment alone or in a combined embodiment, inorganic particles may be added. Preferably, these particles are nanoparticles with diameters in the range of about 5-500 nm, more preferably in the range of about 10-300 nm, but very preferred in the range of about 20-100 nm. Most preferably fumed silica and/or carbon black is (are) added for an improvement of thixotropy with greatly improved results. In some embodiments, the particle concentration is in the range of about 1-70%, preferably of about 1-50%, and most preferably of about 5-40% by weight.

The particle sizes, of both the inorganic and organic polymer particles, can generally be determined using conventional methods. For example, the particle size can be determined by means of particle correlation spectroscopy (PCS), with the investigation being carried out using a Malvern Zetasizer in accordance with the instruction manual. The diameter of the particles is determined here as the d₅₀ or d₉₀ value. The particle diameters indicated are preferably quoted as d₅₀ values.

The particle diameters can generally be determined by means of laser diffraction combined with on-line analysis. To this end, a laser beam is shone into a particle cloud distributed in a transparent gas, for example air. The particles refract the light, with small particles refracting the light at a greater angle than large particles. The scatter angle is thus directly correlated to the particle size. The observed scatter angle increases logarithmically with decreasing particle size. The refracted light is measured by a number of photodetectors arranged at various angles. The measurements are preferably evaluated using Mie light diffraction theory, which is based on Maxwell's electromagnetic field equation. This theory is based on two assumptions. Firstly, it is assumed that the particles to be measured are spherical, but this only really applies to few particles. The measured laser diffraction is used to calculate the volume of particles. Secondly, dilute particle suspensions are assumed. The method usually used to determine particle sizes in the nano range by dynamic light scattering is described in greater detail in the brochure “Dynamic Light Scattering: An Introduction in 30 Minutes”, DLS technical note, MRK656-01 from Malvern Instruments Ltd.

The particle size in the nanoparticulate range can also be determined with the aid of scanning electron photomicrographs (SEM photographs). To this end, particle-containing emulsions can be prepared and applied to a suitable surface in an extremely thin layer in a spin-coating process. After evaporation of the solvent, SEM photographs are taken and the particle diameters recorded are measured. The relative particle diameter of the measured sample is determined by statistical evaluation. Standardised methods for determining particle sizes and devices suitable for this purpose are described in ISO 13321, Methods for Determination of Particle Size Distribution Part 8: Photon Correlation Spectroscopy, International Organisation for Standardisation [(ISO) 1996 (First Edition 1996 Jul. 1)], including methods for determining sizes in the nm measurement range.

Particularly good printing results are achieved on use of pastes comprising powders having particle diameters in the lower range of about 20-100 nm and if the other ingredients, especially the surfactants and encapsulating monomers, are chosen optimally, such that during printing the viscosity is in the range of 10 to 40 Pas. Preference is given to the use of paste compositions which have a viscosity in the range from 10 to 35 Pas and which are stable directly after printing.

The viscosity of the etching pastes described in accordance with the invention is set by means of thickeners and nanoscaled particles which can be varied depending on the desired area of application. Particularly good etching results are achieved if the viscosity of the etching paste prepared is in a range from 10 to 40 Pas. Preference is given to the use of etching pastes which have a viscosity in the range from 10 to 35 Pas.

The viscosity can be determined using a Brookfield rotational viscometer. For this purpose, the viscosity curves are measured at room temperature (25° C.) using a spindle (No. 7) at 5 revolutions per minute and the viscosity is measured under otherwise identical conditions at different rotational speeds up to 50 revolutions per minute. The viscosity can be determined more accurately using a cone-and-plate rheometer, for example an instrument from Haake (Haake RotoVisco 1) or Thermo Electron Corporation.

For the measurement, the sample is located in a shear gap between a very flat cone and a coaxial plate. A uniform shear rate distribution is formed in the measurement gap through the choice of the cone angle. Control takes place via the number of revolutions (CSR) or the torque (CSS). Correspondingly, the number of revolutions or torque respectively is measured. The direct stresses can be derived via force transducers on the drive shaft or on the underside of the cone. In the present case, the measurement system used was a CP 2/35 system, where the cone has a diameter of 35 mm and an angle of 2°. For the measurement, a 2.5 g sample is employed in each case. The viscosity curve is measured automatically under microprocessor control at a temperature of 23° C. with a shear rate in the range 10-75 s⁻¹. The average measurement value is obtained from 20 measurements. The standard value determined is a value at a shear rate of 25 s⁻¹. Corresponding measurement methods are described in greater detail in the standards DIN 53018 and ISO 3210.

If desired, the viscosity can be adjusted by addition of solvent, in the simplest case by addition of water, and/or other liquid components and/or other viscosity assistants.

The pastes according to the invention should have a viscosity in a range from 10 to 40 Pas in order, for example during printing, to ensure a uniform result during printing by the used stencil. Since the pastes according to the invention have thixotropic properties, the viscosity drops under the action of shear forces, meaning that the viscosity varies in a certain range for a specific composition.

Solvents which may be present in the etching media according to the invention are those selected from the group water, isopropanol, diethylene glycol, dipropylene glycol, polyethylene glycols, 1,2-propanediol, 1,4-butanediol, 1,3-butanediol, glycerol, 1,5-pentanediol, 2-ethyl-1-hexanol or mixtures thereof, or solvents selected from the group acetophenone, methyl-2-hexanone, 2-octanone, 4-hydroxy-4-methyl-2-pentanone, 1-methyl-2-pyrrolidone, ethylene glycol monobutyl ether, ethylene glycol monomethyl ether, triethylene glycol monomethyl ether, diethylene glycol monobutyl ether, dipropylene glycol monomethyl ether, carboxylic acid esters, such as [2,2-butoxy(ethoxy)]ethyl acetate, propylene carbonate, in pure form or in the form of a mixture or mixtures which comprise both solvents from the first group and also from the second group.

Especially preferred solvents are water, alcohols or pyrrolidones. The etching media according to the invention usually comprise solvents in an amount of 10 to 90% by weight, preferably in an amount of 15 to 85%, most preferred in an amount of 20 to 35% by weight, based on the total amount of the medium.

Besides compositions according to the present invention may comprise additives selected from the group consisting of antifoams, thixotropic agents, flow-control agents, deaerators and adhesion promoters, which may be present in an amount of from 0 to 2% by weight, based on the total amount. In special cases those ingredients may be contained in higher amounts. But it is possible, that they make up more than 10% by weight on the whole, if the field of application makes it necessary.

Additives having advantageous properties for the desired purpose are commercially available. It goes without saying to the person skilled in the art that the essential factor in this connection is that the addition of such additives improves the product properties.

Additives specifically employed in experiments carried out are also indicated in the examples given below. These may have a positive influence on the printability and on the physical and chemical properties during etching.

Besides the novel etching paste, the present invention also relates to a process for the selective etching of silicon surfaces and layers in which the etching medium is applied over the entire area or selectively in accordance with an etching structure mask specifically only to the areas of the surface at which etching is desired. In a preferred embodiment the deposition of the etching paste is accomplished by screen printing using a specially designed screen. Particularly suitable for the application of etching compositions of the present invention are printing stencils. Immediately when the etching paste is in contact with the surface to be printed it is activated by the exposure to energy radiation, preferably by UV or IR radiation or directly by heat. If a stencil is used for the printing step, this exposure/thermal step can occur before or after the stencil removal when the etching composition is applied to the surface to be etched. After the selected exposure time of some seconds up to several minutes, preferably of about 5 seconds up to 5 minutes, the etching medium is removed again. Usually the etching step takes place at a temperature in the range from higher than 70° C. to about 140° C., but at a temperature lower than 200° C. The temperature has to be in a range which leads to a quick encasing of the etching paste and allows the etching at a sufficiently high rate. Most preferred is a temperature of about 90° C.

Usually the exposure time and temperature induced by irradiation or heat depends on the application, desired etching depth and/or edge sharpness of the etch structures.

After the exposure time and after etching, the etching medium is rinsed off with water or another solvent or with a solvent mixture.

The etching media according to the invention can be used in production processes in semiconductor technology, high-performance electronics or display manufacture, for the production of electronic components or for etching silicon surfaces and layers.

Thus, the present invention provides the user with a new class of etching compositions that enables patterning highly resolved fine features of less than 40 microns, even down to 10 microns or smaller.

Since the use of the etching pastes according to the invention in the semiconductor manufacturing process enables improved etching profiles with better flank steepness to be achieved, it has also become possible to print and etch desired structures closer together. This means that space is gained on the surface and smaller features may be produced.

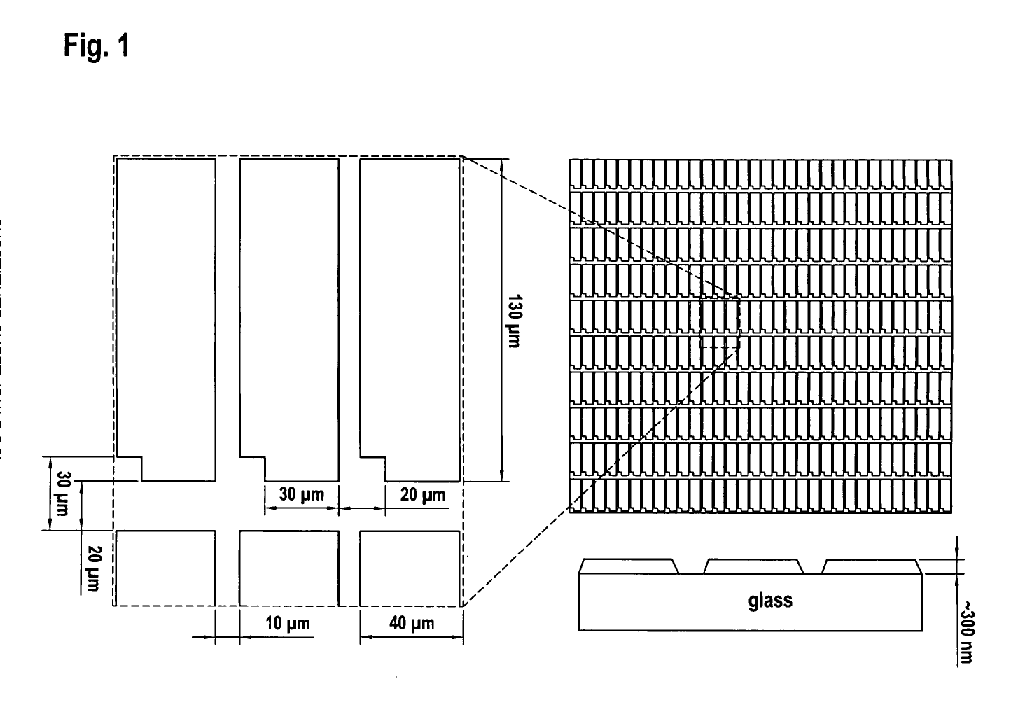

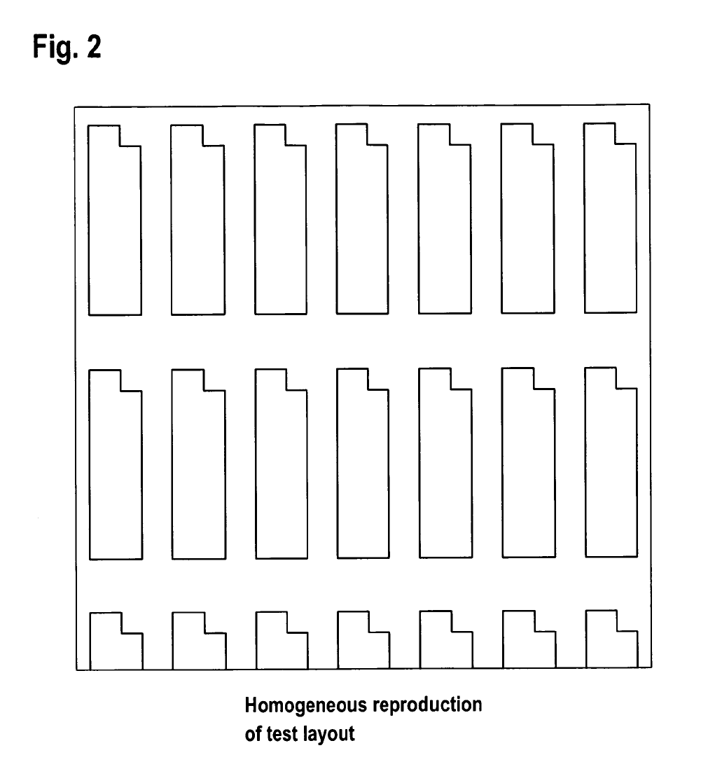

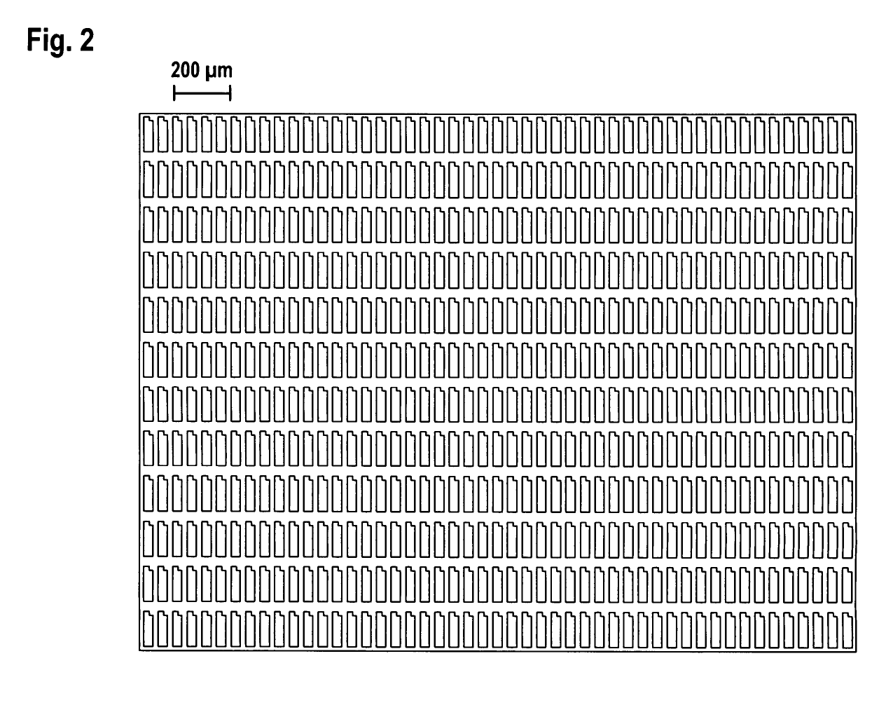

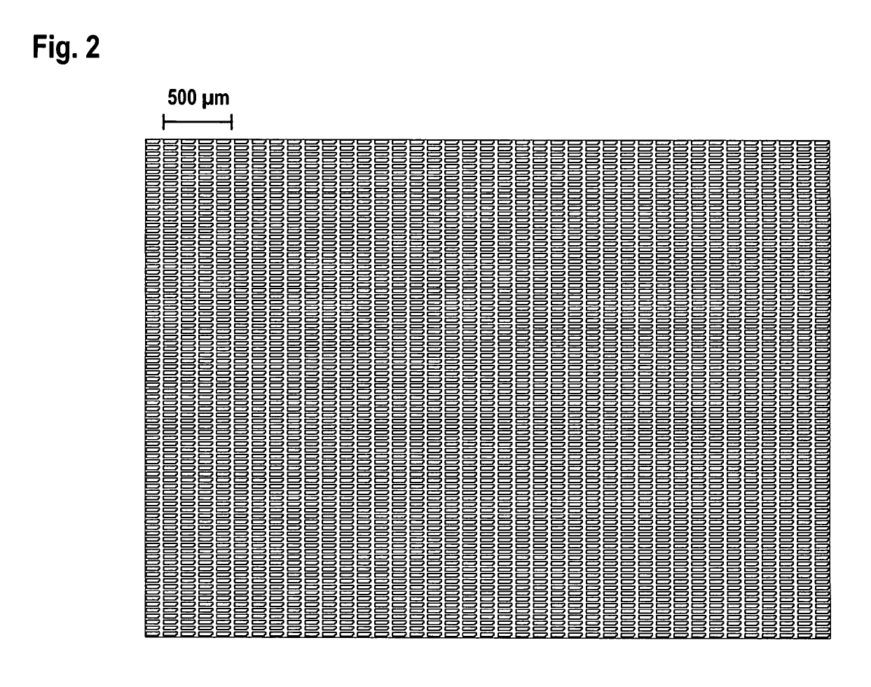

In FIGS. 1 and 2 improved etching results are shown. While in FIG. 1 a layout of feature details of a sample for an etch pattern is shown,

FIG. 2 shows a photomicrograph of an actual homogeneous reproduction of an etched pattern of a test layout in ITO of 150 nm thickness. The micrographs of FIG. 2 show clearly that the designed features and the planned resolution of about 10 μm are realized as well as the steepness of the etched structures.

The present description enables the person skilled in the art to use the invention comprehensively. If anything is unclear, it goes without saying that the cited publications and patent literature should be used. Correspondingly, these documents are regarded as part of the disclosure content of the present description and the disclosure of cited literature, patent applications and patents is hereby incorporated by reference in its entirety for all purposes.

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

The temperatures given in the examples are always in ° C. It furthermore goes without saying to the person skilled in the art that, both in the examples given and also in the remainder of the description, the component amounts present in the paste compositions always add up to a total of 100% by weight, or by volume based on the composition as a whole, and cannot go beyond this, even if higher values could arise from the percentage ranges indicated.

### EXAMPLES

### Example 1

(Cross-Linkable Paste)

50% (v/v) phosphoric acid (concentrated 85%)

30% (v/v) DI water

19.8% (v/v) poly(ethylene glycol) diacrylate (575 g/mol)

0.2% (v/v) Darocure 1173

For the preparation of the formulation phosphoric acid and water are mixed together stepwise while cooling. The phosphoric acid solution is stirred and step-by-step poly(ethylene glycol) diacrylate is added together with the initiator Darocure 1173.

### Example 2

(Cross-Linkable Paste)

48.5% (v/v) phosphoric acid (concentrated 85%)

28.0% (v/v) DI water

18.7% (v/v) poly(ethylene glycol) diacrylate (575 g/mol)

0.2% (v/v) Darocure 1173

4.6% (v/v) Fumed silica

The preparation of the etching formulation is carried out as disclosed in Example 1 and then fumed silica is added while vigorously stirring.

### Example 3

(Cross-linkable Paste)

50% (v/v) phosphoric acid (concentrated 85%)

20% (w/v) polyvinyl pyrrilidone (PVP, 29000 g/mol)

23% (w/v) carbon black

5% (w/v) poly(ethylene glycol) dimethacrylate (PEG-DMA, 1134 g/mol)

2% (v/v) Darocure 1173 or Lamberti SM308

The PVP is dissolved in two-thirds of the phosphoric acid by repeated vigorous shaking and ultrasonication steps. Ultrasonication heats the solution to at least 50° C., although temperature is not controlled. The remaining phosphoric acid is used to dissolve the PEG-DMA. Care is taken to ensure the solution temperature does not rise above room temperature to prevent polymerization. The solutions are then mixed followed by the addition of the initiator and carbon black by mechanical stirring. As before, the solution temperature is controlled such that it does not rise above room temperature.

### Example 4

(Multi-Phase Paste)

50% (v/v) phosphoric acid (concentrated 85%)

25% (w/v) polyvinyl pyrrilidone (PVP, 29000 g/mol)

25% (v/v) polyoxyethylene (20) stearyl ether (Brij S20 or Brij 78)

The PVP is dissolved in the phosphoric acid by repeated vigorous stirring/ultrasonication cycles. Ultrasonication heats the solution to at least 50° C., although temperature is not controlled. The Brij S20 is added in its melted form and vigorous mixing is performed by vortexing and, when highly viscous, mechanically with a stirrer.

### Example 5

(Multi-Phase Paste)

20% (v/v) phosphoric acid (concentrated 85%)

20% (v/v) N-methylpyrrilidone (NMP)

20% (v/v) poly(ethylene glycol) dimethacrylate (1134 g/mol)

40% (v/v) Brij S20

The formulation is mixed as in Example 4 following addition of the NMP to the phosphoric acid.

### Example 6

(Multi-Phase Paste)

33% (v/v) phosphoric acid (concentrated 85%)

67% (v/v) Brij S20

Liquid-phase Brij S20 is added to the phosphoric acid and mixed by vortexing and then mechanically.

### Example 7

(Multi-Phase, Cross-Linkable Paste)

48% (v/v) phosphoric acid (concentrated 85%)

20% (w/v) PVP (29000 g/mol)

5% (w/v) poly(ethylene glycol) dimethacrylate (1134 g/mol)

25% (v/v) Brij S20%

2% (v/v) Darocure 1173 or Lamberti SM 308

Mixing is performed as in Example 3, with the Brij S20 replacing the carbon black.

### Example 8

(Multi-Phase, Cross-Linkable Paste)

30% (v/v) phosphoric acid (concentrated 85%)

8% (w/v) poly(ethylene glycol) dimethacrylate (1134 g/mol)

60% (v/v) Brij S20%

2% (v/v) Darocure 1173 or Lamberti SM 308

Mixing is performed as in Example 3, with the Brij S20 replacing the carbon black and without the PVP.

1. Etching paste comprising components suitable for the encasing of a contained etchant.

2. Etching paste according to claim 1, wherein the encasing of the applied etching composition is induced by irradiation with light, heat or another energy source.

3. Etching paste according to claim 1, wherein the encasing is induced after applying the etching composition onto a surface to be etched whereas simultaneously the etching step is activated.

4. Etching paste according to claim 1 where the components suitable for the encasing are present in a concentration of between about 1-70%.

5. Etching paste according to claim 1 where the components suitable for the encasing are present in a concentration of between about 1-50%.

6. Etching paste according to claim 1 where the components suitable for the encasing are present in a concentration of between about 5-20%.

7. Etching paste according to claim 1, comprising monomer(s) and/or crosslinker(s), selected from the group: olefin, diene, acetylene, acrylate, methacylate, acrylamide, acrylonitrile, vinyl acetate or other vinyl, styrene, and thiol (di, tri, etc) which may be contained as such or as mixtures.

8. Etching paste according to claim 1, comprising a UV/thermal initiator compatible with the comprising monomer(s) and/or crosslinker(s).

9. Etching paste comprising two or more phases and a surfactant in a concentration sufficient for stabilization of the two or more phases.

10. Etching paste according to claim 9 wherein the surfactant is present in a concentration of between about 1-90%.

11. Etching paste according to claim 9 wherein the surfactant is present in a concentration of between about 10-80%.

12. Etching paste according to claim 9 wherein the surfactant is present in a concentration of between about 15-75%.

13. Etching paste according to claim 9, wherein the surfactant comprises at least one of: a hydrophilic moiety, an oleophilic moiety, or a fluorophilic moiety, or a combination thereof.

14. Etching paste comprising two or more phases, a surfactant in a concentration sufficient for stabilization of the two or more phases; and components suitable for the encasing of a contained etchant.

15. Etching paste according to claim 1, comprising inorganic particles in a concentration sufficient to increase the thixotropy of the etching paste.

16. Etching paste according to claim 15 where the inorganic nanoparticles are present in a concentration of 1-70%.

17. Etching paste according to claim 15 where the inorganic nanoparticles are present in a concentration of between about 1-50%.

18. Etching paste according to claim 15 where the inorganic nanoparticles are present in a concentration of between about 5-20%.

19. Etching paste according to claim 15, comprising fumed silica, carbon black, or a combination thereof.

20. Etching paste according to claim 1, comprising phosphoric acid, ferric chloride, oxalic acid, tartaric acid, hydrofluoric acid, sulphuric acid, nitric acid, acetic acid, or a combination thereof.

21. Method for the etching of silicon, silicon dioxide, or indium tin oxide surfaces, characterized in that the etchant is encased to form a gel after the application of the etching composition onto the surface to be etched.

22. Method according to claim 21, wherein the encasing of the etchant is induced by irradiation with light or heat.

23. Method according to claim 21, wherein the encasing of the etchant is induced by temperature-induced removal of a solvent from a two- (or more) solvent system.
